(19) United States
(12) Patent Application Publication
(10) Pub. No.: US 2019/0300193 A1
(43) Pub. Date: Oct. 3, 2019

(54) DRONE WITH MULTIPLE ELECTRIC MOTORS

(71) Applicant: RIEDEL Communications International GmbH, Wuppertal (DE)

(72) Inventor: Thomas RIEDEL, Wuppertal (DE)

(21) Appl. No.: 16/282,359

(22) Filed: Feb. 22, 2019

(30) Foreign Application Priority Data
Mar. 29, 2018 (DE) 102018107586.3

(51) Int. Cl. B64D 35/04; B64D 35/02; B64D 27/24; B64D 45/02; B64F 5/60; B64C 27/06; B64C 27/08; B64C 39/02; B60L 53/16; F16H 1/28

(52) U.S. Cl. CPC B64D 35/04; B64D 35/02; B64D 27/24; B64D 45/02; B64F 5/60; F16D 41/00; B64C 27/08; B64C 39/024; B60L 53/16; F16H 1/28; B60L 2200/10; B64C 27/06

(57) ABSTRACT

Inter alia, the invention relates to an aerial device (10), comprising at least one rotor (12, 12a, 12b) that generates lift forces that, using a controller (18), can be addressed by a drive (16, 16a, 16b), wherein the drive (16, 16a, 16b) comprises an electromotively-driven rotor drive shaft (29). The particular feature of the invention is, among other things, that the drive (16, 16a, 16b) comprises a plurality of electric motors (25, 26, 27) that jointly drive the rotor drive shaft (29).

The invention initially relates to an aerial device according to the preamble of claim 1.

Such aerial devices are known, for example, under the term drone, multicopter or helicopter, and are used for many different purposes. Corresponding aerial devices are extensively used and developed by the applicant. In terms of prior art, reference is made to the later published patent applications DE 10 2018 101 556 A1 and DE 10 2017 105 956 [US 2018/0273171] as well as EP 18161486, all of which originate from the applicant.

Such aerial devices may comprise one or multiple rotors. In multicopters, multiple rotors are provided that generate lift forces. In helicopters, usually one rotor, or a double rotor that generates lift forces, is provided, wherein a side-rudder or a steering rudder in the form of another smaller rotor can be provided additionally, which rotor usually generates no or only negligible lift forces, however.

The rotor can be addressed by a drive, wherein this occurs using a controller that is assigned to the aerial device, in particular forms an integral part of the aerial device. The controller can control the rotational speed and/or the power output of the drive, for example, in order to cause a corresponding alteration of the flight position of an aerial device.

The rotor is driven directly or indirectly by interposition of a rotor drive shaft. In an aerial device of the prior art according to the preamble of claim 1, the rotor drive shaft is driven by an electric motor.

On the basis of an aerial device having the features of the preamble of claim 1, the object underlying the invention is to develop this aerial device in such a way that the aerial device can also be used in permanent operation, and/or has a longer service life.

This object is achieved by the invention with the features of claim 1, in particular the features of the characterizing part, and accordingly is characterized in that the drive comprises a plurality of electric motors that together drive the rotor drive shaft.

The principle of the invention is that a rotor is not driven by only one electric motor—as in the prior art—but instead to provide a plurality of electric motors. These motors jointly drive the rotor drive shaft. These motors in particular cooperate with the surface, in particular the outer surface or the inner surface of the rotor drive shaft that, for this purpose, can comprise teeth, for example. The electric motors have respective pinions that mesh with this teeth. In this way, multiple regions of effect can be arranged along the surface of the rotor drive shaft, on which a transmission of force, more precisely a transmission of torques, from the individual pinions of the respective electric motor to the rotor drive shaft can be effected.

For example, it can be provided that the rotor drive shaft is a sun gear of a planetary gear assembly, and the multiple electric motors respectively cooperate with the rotor drive shaft via pinions, wherein the pinions are arranged like planet gears of a planetary gear assembly and cooperate with the sun gear. However, the specific feature lies with the fact that the pinions of the electric rotors are arranged rotatably, but stationary in the planetary gear assembly. Further advantageously, these pinions of the multiple electric motors are spaced equiangularly around the surface of the rotor drive shaft, or around a rotation axis of the rotor drive shaft.

According to the invention, the drive power of the rotor required in the prior art, which had to be generated only from a single electric motor, is divided among multiple electric motors. One the one hand, this allows a redundant configuration of the drive. If, for example, one electric motor fails, or if an error or wear are identified, the other remaining electric motors can assume the tasks of the electric motor that has failed.

On the other hand, also a higher rotor drive power can be achieved, as the individual powers of the multiple electric motors add up.

Finally, a higher service life or longevity of the aerial device is in particular also achieved, as the individual electric motors are not stressed that much.

Permanent use of aerial devices is also improved, for example in the context of a use as a flying mast of a radio network or as a lightning protection, as have been described in the above, later published patent applications of the applicant.

Finally, it has been found by the invention that the main reason for the aging of an electric motor is to be traced back to an excessive heat-up of the components and a high stress of the mechanic bearings.

Furthermore, it has been found by the invention that in large, high-performance electric motors, the cooling of the components becomes more complex as the motor power output increases, because the magnetically-active volume increases significantly, but the surface area usable for cooling purposes does not increase to the same extent. In the prior art, likewise high stress of the rotary bearings in the motors occurs, in particular due to the existing bending moments acting upon the motor shaft.

Due to the fact that, according to the invention, a split-up of the electric motor into multiple small electric motors is made, an improved cooling of the individual electric motors can be achieved, because a relatively larger surface are available for cooling purposes is achieved at the same drive power.

Planetary gear assemblies are generally known in the teaching of gear mechanisms. However, the orbiting planetary gears arranged around a sun gear are usually only used for the transmission or the reduction of the drive, i.e. to alter the rotational speed, and, in particular, are not arranged stationary.

According to the invention, the option of arranging the multiple electric motors, in particular the respective pinions thereof, equidistantly around a rotation axis of the rotor drive shaft, is provided, so that a symmetric support of the rotor drive shaft can be effected. Bending moments exerted by the rotor are therefore transmitted symmetrically by multiple electric motors, supported via the tube shaft, and the sun gear, and taken-up by the electric motors, so that the resulting bending moments do not have severe effects.

Owing to the inventive, compact and symmetric split-up of power, a longer service life of the aerial device can be achieved. At the same time, the aerial device can be produced at lower costs.

According to an advantageous configuration of the invention, the rotor drive shaft is directly or indirectly connected with the rotor. The rotor drive shaft is advantageously configured as a tube shaft and is the element in the drive train that is connected to the plurality of the electric motors via multiple force transmission regions or torque transmission regions or regions of effect. The rotor drive shaft can directly be connected with the rotor, or by interposition of other torque-transmitting elements, also by interposition of a gear mechanism arranged between rotor drive shaft and rotor, as the case may be, possibly also with a speed reduction or increase. Advantageously, the rotor drive shaft is directly connected to the rotor, so that the rotational speed of the rotor drive shaft corresponds to the rotational speed of the rotor.

According to another advantageous configuration of the invention, the rotational speed of the rotor drive shaft is proportional to the rotational speed of the rotor. Insofar, this embodiment is provided with an additional gear mechanism.

According to another advantageous configuration of the invention, the rotational axis of the rotor drive shaft is identical with the rotational axis of the rotor. In further embodiments of the invention, the rotational axis of the rotor drive shaft is oriented axis-parallel or transversely or inclined to the rotational axis of the rotor. In the examples of the invention described last, further torque-transmitting or force-transmitting elements are provided in the drive path between rotor drive shaft and rotor.

It is to be noted here that the rotor may only comprise one, or alternatively multiple rotor blades.

According to another advantageous embodiment of the invention, the rotor drive shaft is a tube shaft. At a low weight, the tube shaft provides the option of providing multiple different force or torque transmitting regions on its inner surface or outer surface, on each of which a transmission of torque on to the tube shaft by means of one electric motor of the plurality of electric motors is achieved. The rotor drive shaft can be provided with teeth on the outer or inner surface thereof, for example. The teeth can cooperate with a pinion of an electric motor, for example. Advantageously, multiple pinions of the plurality of electric motors are arranged along the surface of the tube shaft, further advantageously around the rotation axis of the motor drive shaft. Further advantageously, the plurality of electric motors, in particular the plurality of pinions of the plurality of electric motors, are arranged around a rotation axis of the rotor drive shaft, in an equidistant arrangement, and thus act equidistantly on different force-transmitting or torque-transmitting regions on the rotor drive shaft. In this way, a symmetric arrangement and a correspondingly symmetric transmission of torque is achieved.

The plurality of electric motors advantageously rotate at the same rotational speed. As a result, a uniform application of the rotor drive shaft can be obtained. Further advantageously, the plurality of electric motors each have a respective pinion that meshes with the teeth. In terms of construction, a particular simple structure can be achieved hereby.

According to another advantageous embodiment of the invention, the respective pinion is assigned a freewheel mechanism that in the case of failure of an electric motor allows the pinion to run freely. The freewheel mechanism can be arranged directly on the pinion, or be provided between the pinion and the electric motor. In an alternative configuration, it can likewise be provided along the intermeshing teeth of pinion and rotor drive shaft, for example by a corresponding design of the tooth flanks of teeth of the pinions and of teeth of the rotational shaft. In the case of a failure of an electric motor, for example if the respective output shaft of the electric motor is blocked, the freewheel mechanism ensures that the rotor drive shaft of the can continue to be driven by the remaining electric motors of the plurality of electric motors without a blocking of the rotational movement of the rotor drive shaft occurring due to the failure of the electric motor.

According to another advantageous embodiment of the invention, the rotor drive shaft is the rotating sun gear of a planetary gear mechanism or of a planetary gear mechanism assembly. Further advantageously, the pinions of the plurality of electric motors are arranged in the type of stationary planets of the planetary gear mechanism or of the planetary gear mechanism assembly. In other words, the pinions are arranged around the sun gear in the type of planets, and jointly drive this sun gear.

All pinions of all electric motors rotate in the same rotation direction, and thus all in the opposite direction to the rotation direction of the rotor drive shaft.

According to another advantageous embodiment of the invention, the aerial device obtains its operating voltage from an accumulator or a corresponding battery, arranged on the aerial device. According to an alternative and advantageous configuration of the invention, the aerial device is connected to a ground station during flight operation via a voltage supply cable. In this embodiment, the aerial device obtains its operating voltage from the ground station.

In this way, the aerial device can be used permanently in permanent operation, for example for providing a lightning protection for an event site, or for providing a transmission mast of a radio network, in particular maintaining a set flight position.

According to another advantageous embodiment of the invention, the controller comprises means for permanently maintaining a set flight position for the aerial device. Such a setting of the flight position can for example be conducted in a wire-bound or wireless manner, or using a controller arranged in the area of the ground station. With a flight position once set, the means can ensure that the set flight position is maintained.

According to another advantageous embodiment of the invention, the plurality of electric motors respectively have the same or substantially same power. According to the invention, the power of the individual electric motors adds up to a total drive power for the rotor.

According to another advantageous embodiment of the invention, the plurality of electric motors, in a normal operation of the aerial device, contribute to the total drive power of the rotor at equal or substantially equal power proportions. In this way a uniform utilization and a uniform wear of the plurality of electric motors are ensured.

According to another advantageous embodiment of the invention, the aerial device comprises a device for detecting a failure or an error or the occurrence of wear on one or on multiple electric motors. The device can, for example with the help of sensors, detectors or monitoring means, monitor a proper functioning of the electric motors, and, in the case an error or a failure or an of amount wear occurs, report this situation to the controller of the aerial device, or, as the case may be, also to a controller on the ground station.

According to another advantageous embodiment of the invention, the controller activates, in the case of a failure or an error or wear of one of the electric motors, at least one of the plurality of electric motors, for the purpose of a partial or complete compensation and/or assumption of the lost power. In this respect, there is the option that in the case of failure of on electric motor, the remaining electric motors assume the function of the said motor, and ensure that the aerial device continues its operation—at least for a certain time—, or at least remains controllable or steerable, in order to safely return to the ground or to a starting point of the flight.

According to another advantageous configuration of the invention, the aerial device comprises a braking device. This device can, in particular, be provided for acting on the rotor drive shaft in the case of occurrence of an error. The braking device can for example be arranged on the teeth or on another point of the rotor drive shaft or an element arranged upstream or downstream, rotationally connected with the rotor drive shaft, and, in a manner centrally acting on the drive shaft, decelerate, hinder or prevent the rotation of the rotor drive shaft.

According to another advantageous embodiment of the invention, the aerial device is a drone or in the type of a helicopter or in the type of a multicopter.

According to another advantageous configuration of the invention, the aerial device is equipped with means for providing a radio connection, in particular an antenna and/or an electronic transmitting or receiving means. For this purpose, it can be provided that the aerial device is connected not only to a voltage supply line to the ground station, but additionally also to a data line, in particular a glass fiber data line, as described in the above-described patent application of the applicant.

According to another advantageous embodiment of the invention, the aerial device is equipped with means for bringing about a lightning protection for an event site. For this purpose, reference is also made to the above-described patent application of the applicant, in order to avoid repetitions.

Further advantages of the invention result from the non-cited sub-claims, as well as by means of the following description of the embodiments illustrated in the drawings. The figures show in:

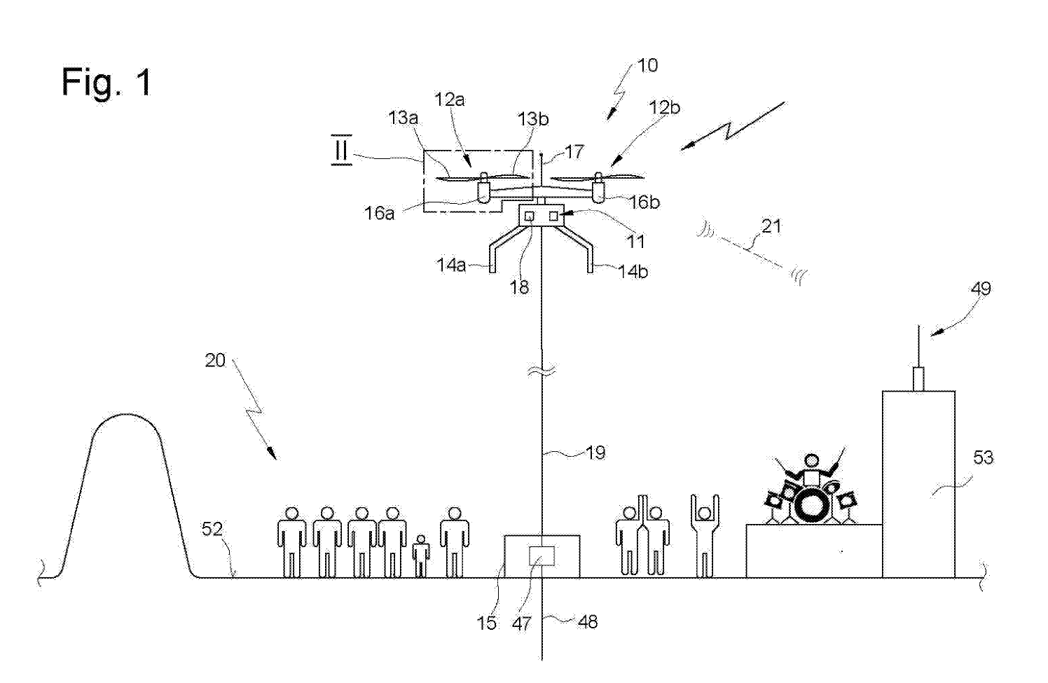

FIG. 1 a partially sectional block-circuit diagram-type schematic illustration as an embodiment of an aerial device according to the invention that is connected to a ground station via a voltage supply line, the aerial device being above an event site,

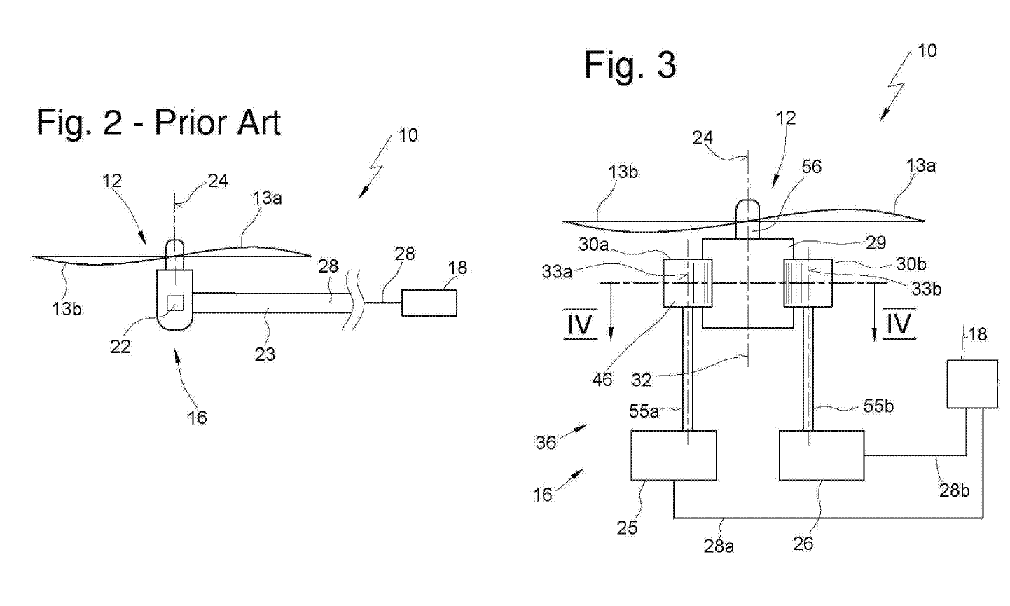

FIG. 2 an enlarged, partial-sectional, block-circuit diagram-type schematic illustration as a detail of a region of the aerial device of FIG. 1, roughly along the enlarged partial-circular view II of FIG. 1 where for reasons of clarity, FIG. 2 illustrates an embodiment of an aerial device of the prior art,

FIG. 3 n an illustration comparable to the illustration of FIG. 2 of an embodiment of an aerial device according to the invention by illustrating a drive with the plurality of electric motors for driving a rotor drive shaft;

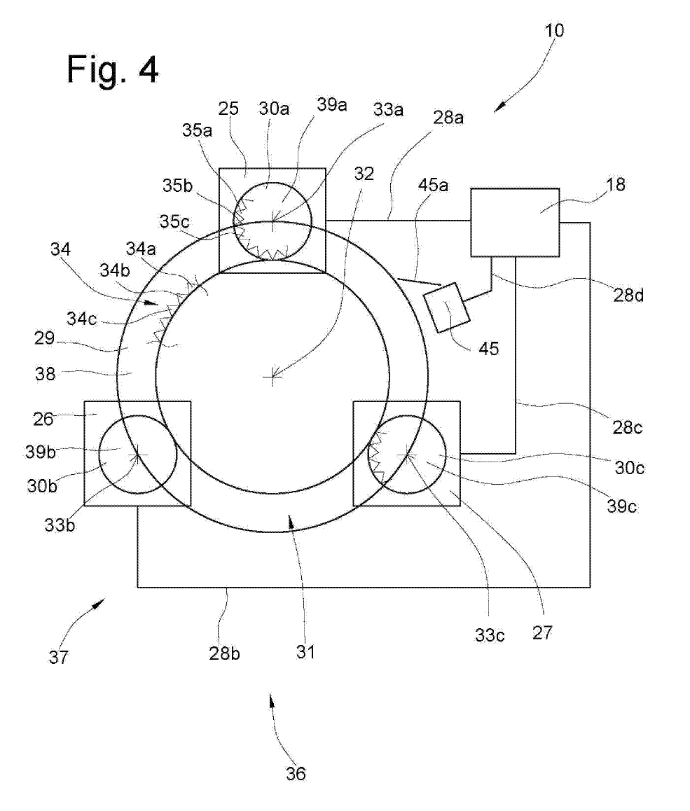

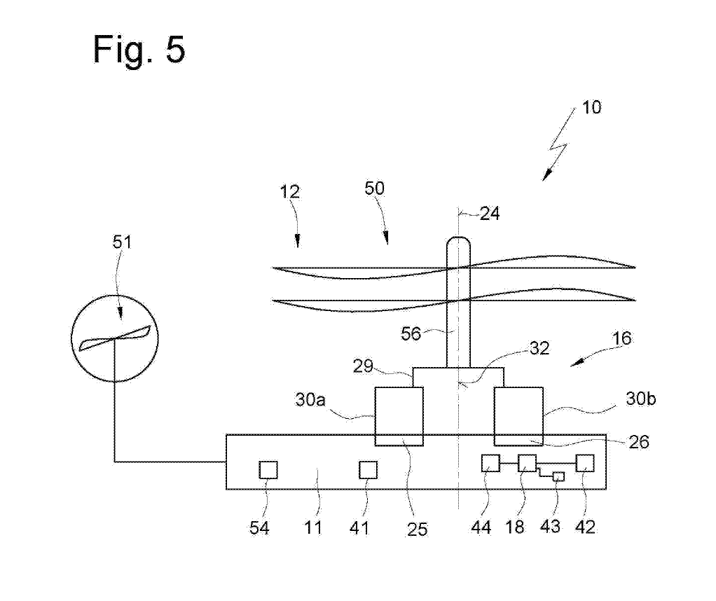

FIG. 4 the embodiment of FIG. 4 in a partly sectional schematic principle view roughly along sectional line IV-IV of FIG. 3;

FIG. 5 another embodiment of an aerial device according to the invention, configured as a helicopter,

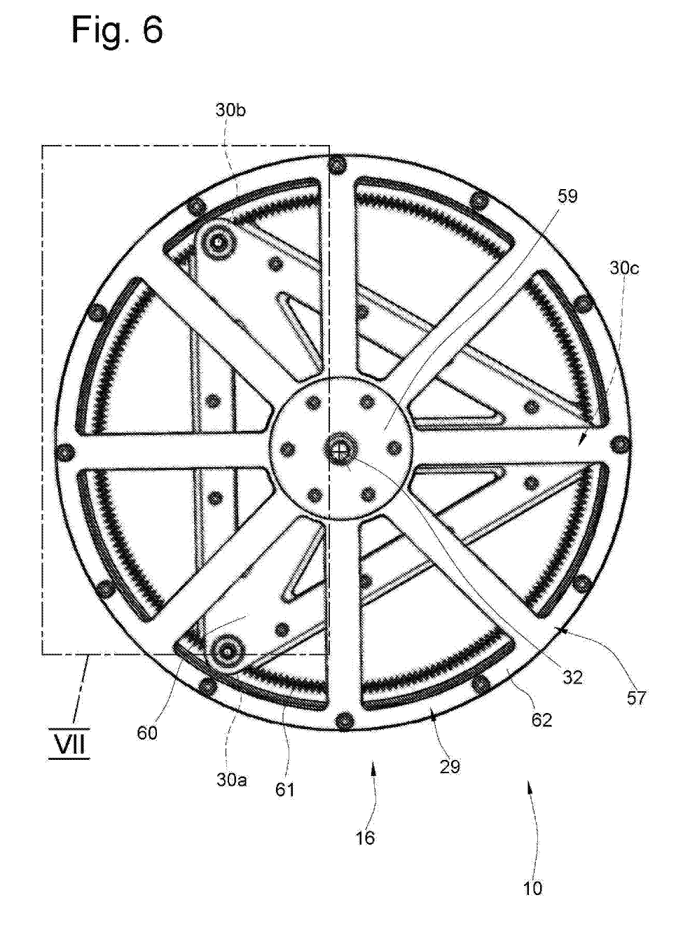

FIG. 6 a partially-sectional, schematic top view of another embodiment of an aerial device according to the invention in a schematic principle outline similar to FIG. 4 where in this case the rotor drive shaft is formed as a spoked wheel and three electric motors are connected to one another via a triangular support;

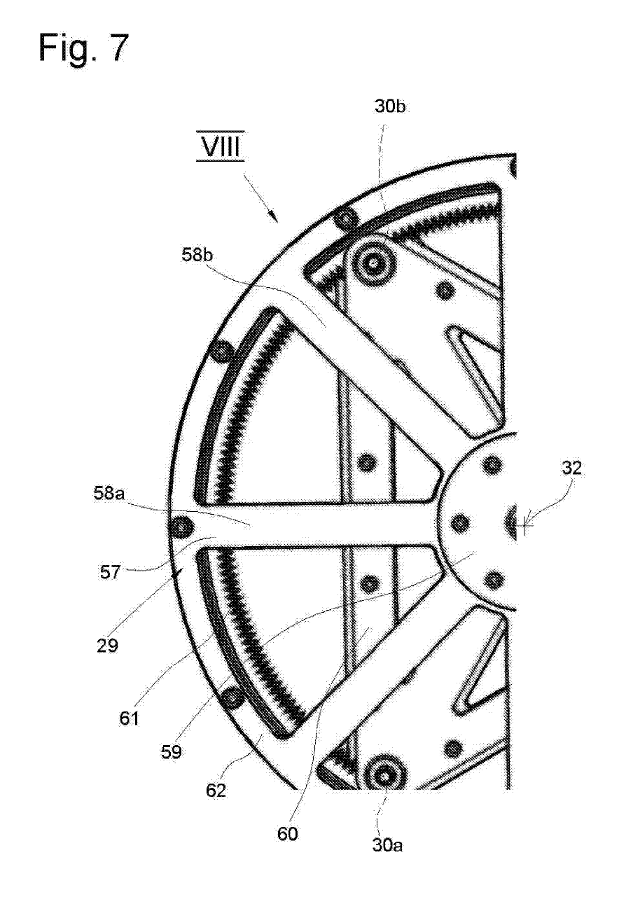

FIG. 7 an enlarged view of a detail of the embodiment of FIG. 6 in an illustration roughly corresponding to the partial circle VII in FIG. 6, and

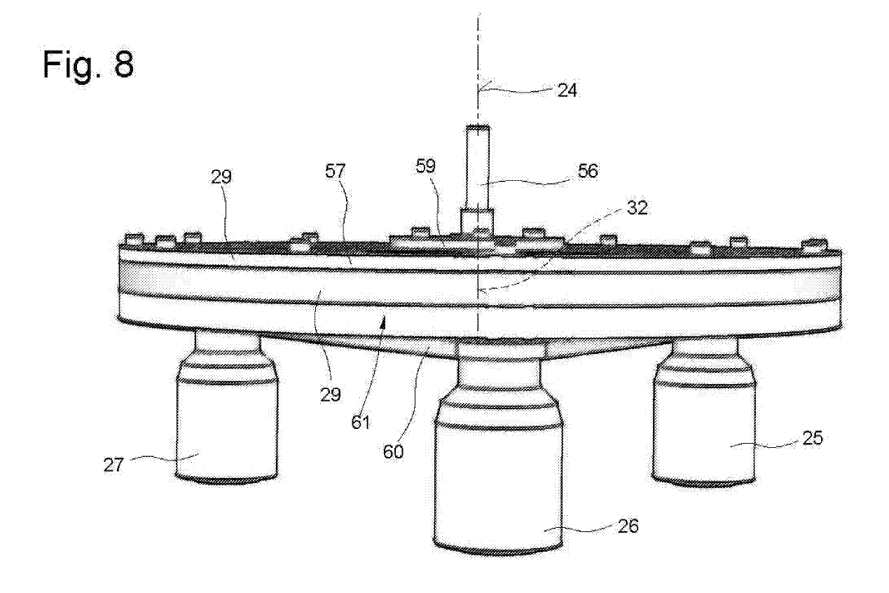

FIG. 8 a schematic sectional side view of the aerial device in an illustration roughly corresponding to the image arrow VIII of FIG. 7.

Embodiments of the invention are described by way of example in the below description of the Figures, also with reference to the drawings. Here, for reasons of clarity, also as far as different embodiments are concerned, like or similar parts or elements or regions are denoted with the same reference characters, some of them with lowercase letters.

Features that are described only with reference to one embodiment can, within the scope of the invention, also be provided in any other embodiment of the invention. Embodiments modified in such a manner are within the scope of the invention—even if they are not illustrated in the drawings.

All of the features disclosed are per se essential to the invention. Therefore, the disclosure content of the associated priority documents (copy of the prior application) and of the recited documents and the described devices of the prior art is also incorporated in its entirety in the disclosure of the application, also for the purpose of incorporating individual or multiple features of these documents in one or multiple claims of the present invention.

In the following, the invention is explained by means of multiple embodiments:

According to FIG. 1, a first embodiment of an aerial device 10 according to the invention is illustrated in a schematic principle outline in the type of a block circuit diagram:

Here, the aerial device 10 according to the invention is a multicopter and comprises two rotors 12a, 12b that are arranged on a body 11 or on a support frame or a support 11. The term “multicopter” indicates that the number of rotors 12a, 12b on the aerial device 10 is arbitrary. The invention includes aerial devices with one or multiple rotors 12a, 12b of this type. As the embodiment of FIG. 5 illustrates, the invention further includes aerial devices 10 formed in the type of helicopters, and, for example, comprise a double rotor 50 with adjustable pitch, i.e. adjustable inclination. The embodiment of FIG. 5 further shows yet another rotor in the form of a side-rudder 51.

The aerial device 10 according to the invention comprises at least one rotor 12, 12a, 12b that ensures the lift of the aerial device 10. The respective rotor may comprise one or multiple rotor blades 13a, 13b. In all of the embodiments of the drawing, the rotor 12 comprises two rotor blades 13a, 13b, with the number of rotor blades being arbitrary.

In the embodiment of FIG. 1, the aerial device 10 comprises two or more legs or feet 14a, 14b that make a safe landing of the aerial device 10 on the ground 52 possible. Such feet 14 are not mandatory, however.

As can be taken from the embodiment of FIG. 1, the aerial device 10 is connected to a ground station 15 via a voltage supply cable 19. In this embodiment, the aerial device 10 is operable over very long time periods. In another embodiment, for example according to FIG. 5, the aerial device is provided with an accumulator 41 or with a battery. The invention also relates to aerial devices 10 that comprise both, a terminal for a connection to a voltage supply cable 19 and a terminal for a battery 41.

In the embodiment of FIG. 1, the aerial device 10 comprises a controller 18 that, in a manner not illustrated in FIG. 1, cooperates with two drives 16a, 16b for the rotors 12a, 12b. Here, each rotor 12a, 12b is assigned a distinct drive 16a, 16b. The invention also covers the case in which a drive 16 drives multiple rotors 12a, 12b.

In the embodiment of FIG. 1, the ground station 15 comprises a distinct control device 47 that can cooperate with the controller 18. In other embodiments, the control device 18 in the aerial device 10 is autarkic from the ground station 15.

In order to control the aerial device 10, the controller 18 can receive control signals either in a wired or wireless manner from a remote control (not illustrated) that is controllable in particular by an operator. This way, the operator can, for example, set a certain flight position that is located for example exactly or basically above the ground station 15. The aerial device 10 can comprise means 42 (see FIG. 5) for maintaining the position so that the aerial device 10 can keep and maintain a once set flight position permanently or at least for a predetermined longer period of time. The means 42 for keeping position and maintaining position can in this case cooperate with sensors and suitable electric and electronic components, in order to make corrections to the current flight position, for example by means of a position check or an inclination check, and to activate the drives 16a, 16b via the controller 18 in such a way that the target flight position is reached or maintained using the rotors 12a, 12b.

In the embodiment of FIG. 1, the aerial device 10 is arranged above an event site. In a schematic illustration, a group of persons and a drummer can be discerned, to illustrate a music event. On a schematically-illustrated building 53, a return radio station 49 is arranged, to which a radio path 21 can be established via the antenna 17 or via a (non-illustrated) transceiver unit for radio signals, arranged on the aerial device 10. The raised aerial device 10, arranged far above the location 20, can, due to its raised position, particularly advantageously establish a direct, i.e. unblocked and unobstructed radio path 21 to other participants 49 of a radio network.

In another, possibly additional or alternative purpose of use, the aerial device 10 can have a lightning protection (c.f. FIG. 5) so that high currents created by a lightning strike can be conducted via the line 19 to the ground station 15, as well as to a conductor in the ground and to a voltage transfer point located deep below. Advantageously, in this case, the voltage supply cable 19 is additionally equipped with a conductor that can safely forward high currents occurring in a lightning strike.

As can be taken from the illustration of an aerial device 10′ from the prior art according to FIG. 2, firstly, it is to be explained that the prior art aerial device 10′ in each case had one rotor 12 and one drive 16 that comprises only one electric motor 22. The electric motor 22 was connected to the controller 18 of the aerial device 10.

FIG. 2 is only to be understood as purely schematic: The rotor 12, together with the drive 16, is connected to the body 11, which is not illustrated in FIG. 2, or the support frame 11 of the aerial device 10 via a mechanical holder 23.

An aerial device 10 according to the invention and the functional principle thereof is now to be explained by means of the embodiment of FIG. 3:

In this case, the drive 16 is configured such that two or more electric motors 25, 26, which are independent from one another, are assigned to a rotor 12. The electric motors 25, 26 are connected to the controller 18 of the aerial device 10 via electric control lines as well as connecting lines 28a, 28b.

The first electric motor 25 comprises a pinion 30a, i.e. a toothed gear that is rotatable about a pinion axis 33a. The electric motor 25 is connected to the pinion 30a via an output shaft 55a.

The electric motor 26 is connected to a distinct pinion 30b via an output shaft 55b. This pinion is rotatable about a pinion axis 33.

As can be taken from the embodiment of FIG. 3, only two electric motors 25, 26 and two pinions 30a, 30b are discernable. In fact, FIG. 4 shows that in this embodiment of FIG. 3, an equidistance arrangement, offset by 120°, including three electric motors 25, 26, 27 and accordingly three pinions 30a, 30b, 30c, is provided.

Each pinion 30a, 30b, 30c comprises an external teeth, illustrated by way of example by the teeth 35a, 35b, 35c. The teeth 35a, 35b, 35c mesh with teeth 34 on a rotor drive shaft 29. The rotor drive shaft 29 is configured as a tube shaft 31 and comprises an external teeth 34. The rotation axis of the rotor drive shaft 29 is denoted with 32 in the Figures. In all of the embodiments, the rotation axis 32 of the rotor drive shaft 29 is identical to the rotational axis 24 of the rotor 12. In non-illustrated embodiments of the invention, these two rotational axes 32, 34 can also be apart, or be oriented one to the other in an arbitrary manner.

In all of the embodiments, the rotational axes 33a, 33b, 33c of the pinions 30a, 30b, 30c are arranged parallel to the rotor drive shaft 29, though axially-spaced from it.

Pinions 30a, 30b, 30c of the embodiment of FIG. 4 move in the same direction, i.e. in the same direction of rotation. Accordingly, the rotor drive shaft 29 is driven in the opposite direction of rotation.

The rotor drive shaft can directly rotate the rotor 12, possibly by interposing a connection bolt or a connection piece 56. Advantageously, the rotor 12 rotates at the same rotational speed as the rotor drive shaft 29. However, in other embodiments of the invention, a reduction gear, or a transmission gear, can be present between drive shaft 29 and rotor 12.

As can be taken from the principle view of FIG. 4, a planetary gear mechanism 37 is provided:

The central, rotating sun gear is formed by the rotor drive shaft 29.

The three drive pinions 30a, 30b, 30c constitute the planets of the planetary gear mechanism 37, wherein the planets 39a, 39b, 39c—in contrast to conventional planetary gear mechanisms—are arranged stationary. The rotor drive shaft therefore constitutes the sun 38 of the planetary gear mechanism, and the pinions 30a, 30b, 30c constitute the planets 39a, 39b, 39c.

Each of the three electric motors 25, 26, 27 is connected to the controller 18 of the aerial device 10 via a signal or control line 28a, 28b, 28c. Advantageously, the three electric motors 25, 26, 27 have the same or substantially the same power, and/or are activated by the controller 18 in such a way that they contribute to the total drive power of the rotor at equal or substantially equal power proportions.

In the embodiment of FIGS. 3 to 5, one drive 16 having a plurality of electric motors 25, 26, 27 is respectively connected to a rotor 24. However, the invention also covers the situation where a plurality of rotors 12a, 12b are driven by one drive 16.

According to the invention, the rotor drive power required or desired for an operation of the aerial device 10 can be distributed among multiple electric motors 25, 26, 27. Here, the number of electric motors can be freely selected. The embodiments show a drive 16 with three electric motors 25, 26, 27, wherein, however, also two, four, six to ten or another number of electric motors are alternatively conceivable and covered by the invention.

If one of the electric motors fails, a high system stability can be ensured by a corresponding configuration of the overall system and in particular in knowledge of the total drive power required. In the case of a power failure of an electric motor 25, the remaining electric motors 26, 27 can take over, for example.

The individual electric motors 25, 26, 27, which, in contrast to the prior art, are of smaller dimensions allow to be cooled better and with simpler means, compared to the prior art.

As can be taken from the embodiment of FIG. 5, the invention also covers aerial devices 10 in which rotors 12 configured as multirotor, for example as shown in FIG. 5, as a double rotor, are provided. The invention also covers aerial devices according to FIG. 5 that, in addition to the one or the plurality of rotors 12, 12a, 12b, further comprise a side rudder 51. The rotatory motion of the side rudder 51 can be derived by the same drive 16 that also drives the rotor 12, 50. However, the invention also covers the situation where the side rudder 51 has a distinct drive.

The individual electric motors 25, 26, 27 are controllable independently of one another by the controller 18 via the separate signal or control lines 28a, 28b, 28c.

If means 43 (c.f. FIG. 5), arranged on the aerial device 10, identifies, via a corresponding detection, a failure of one of the electric motors 25, 26, 27, or the occurrence of wear, the means 43, possibly using means 44 for reporting errors, can report this situation as an error to the controller 18. The controller 18 thereupon can cause that the power hitherto provided by the failed electric motor can be compensated for by the remaining electric motors, by making available a corresponding power.

As can be taken from the embodiment of FIG. 4, it is to be indicated that the aerial device 10 according to the invention can optionally have a braking device 45. As can be taken from FIG. 4, the braking device 45 comprises a braking element 45 that can cooperate with the rotor drive shaft 29 in terms of a braking operation. The braking device 45 can be connected to the controller 18 via a control line 28d.

In the case of a complete failure of the aerial device 10, it is required or at least desired, due to legal provisions, that at the time when the aerial device 10 hits the ground it will not have any rotating or rotatory parts that could be harmful to persons or animals, or damage objects. In the case of such an emergency, the controller 18 can cause that the braking element 45 is shifted from the resting position illustrated in FIG. 4 to a (non-illustrated) operating position, for example with the help of a drive motor, in order to quickly and efficiently block the rotary motion of the rotor drive shaft 29 about its axis of rotation 32, in a centralized manner, for example by friction fit.

As can be taken from the embodiment of FIG. 3, it is further to be explained that the aerial device 10 can optionally be equipped with a freewheel mechanism 46. The freewheel mechanism 46 can for example be arranged in the connecting region between an electric motor 25 and the pinion 30a, for example in particular the connecting region between the output shaft 55 and pinion 30a. Likewise, a respective freewheel 46 can be provided at any other pinion 30b, 30c.

The freewheel device 46 serves to ensure, in case of a failure of an electric motor 25, that the remaining electric motors 26, 27 can continue driving the rotor drive shaft 29 in the drive direction by a rotational movement of their pinions 30b, 30c, but the pinion 30a does not block nor counteract this rotational movement, but allows a freewheeling here. These freewheel clutches are well known from other technical fields, so that a detailed description is omitted.

As can be taken from the embodiment of FIGS. 6 to 8, an alternative configuration of a drive 16 of an aerial device 10 according to the invention is now described, in which the essential elements of the invention—similar to the illustration of FIG. 4—are omitted.

FIG. 6 shows the drive 16 in a perspective viewing direction, similar to that in FIG. 4. However, multiple constructional details are discernible in FIG. 6:

In the embodiment of FIGS. 6 to 8, the rotor drive shaft 29 is formed by a spoked wheel 57 or includes such a wheel. Starting from a radial center, this wheel comprises a plurality of spokes 58a, 58b that connect the center to an outer rim 62.

The rim 62 has an internal teeth 61 arranged on it that is configured so as to be on the entire surface and comprises a plurality of teeth.

Just as well, three electric motors 25, 26, 27 are provided that can best be discernible in FIG. 8. Each electric motor 25, 26, 27 is assigned a pinion 30a, 30b, 30c, which, in a manner not illustrated here, cooperates with corresponding teeth of the internal teeth 61.

Using a triangular support element 60, the three pinions 30a, 30b, 30c are fixedly connected or fixedly positioned to one another. As a result, the drive 16 achieves a stable structure at low weight.

The rotor drive shaft 29, configured as a spoked wheel 57 here, is equipped with a flange connector 59, on which the connecting bolt 56 acts, as can be seen in FIG. 8. The rotor 12 (not illustrated), co-rotationally connected with the rotor drive shaft 59, is located above the connecting bolt 56 illustrated in FIG. 8.

In the embodiment of FIGS. 6 to 8, the rotor axis 24 again corresponds to the rotational axis 32 of the rotor drive shaft 29.

1. An aerial device, comprising:
at least one rotor that generates lift forces;
a controller,
a drive including an electromotively driven rotor drive shaft and a plurality of electric motors that jointly drive the rotor drive shaft.

2. The aerial device according to claim 1, wherein the rotor drive shaft is directly or indirectly connected to the rotor.

3. The aerial device according to claim 1, wherein a rotational speed of the rotor drive shaft corresponds to or is proportional to a rotational speed of the rotor.

4. The aerial device according to claim 1, wherein the rotor drive shaft is a tube shaft.

5. The aerial device according to claim 1, wherein the rotor drive shaft is provided on its outer surface with teeth or has internal teeth.

6. The aerial device according to claim 1, wherein the plurality of electric motors are angularly spaced around a rotation axis of the rotor drive shaft opposite one another.

7. The aerial device according to claim 1, wherein the plurality of electric motors or the pinions of the electric motors are equiangularly spaced around a rotation axis of the rotor drive shaft.

8. The aerial device according to claim 1, wherein the plurality of electric motors or the pinions rotate at the same rotational speed.

9. The aerial device according to claim 5, wherein the electric motors have respective pinions that mesh with the teeth.

10. The aerial device according to claim 1, wherein each pinion has a freewheel mechanism that allows rotation the pinion on failure of the respective electric motor.

11. The aerial device according to to claim 1, wherein the rotor drive shaft is a rotating sun gear of a planetary gear mechanism and the pinions of the plurality of electric motors are planet gears of the planetary gear mechanism.

12. The aerial device according to claim 1, wherein the aerial device receives its operating voltage from an accumulator on the aerial device.

13. The aerial device according to claim 1, wherein the aerial device receives its operating voltage from a ground station to which it is connected in flight via a voltage supply cable.

14. The aerial device according to claim 1, wherein the controller includes means for permanently maintaining a set flight position of the aerial device.

15. The aerial device according to claim 1, wherein the plurality of electric motors each have the same or substantially the same power.

16. The aerial device according to claim 1, wherein during normal operation of the aerial device, the plurality of motors contribute to the total drive power of the rotor at equal or situationally equal power proportions.

17. The aerial device according to claim 1, wherein means is provided on the aerial device for detecting a failure or an error or the amount of wear of one of the electric motors.

18. The aerial device according to claim 1, wherein means is provided for reporting the failure or the error or the amount of wear to the controller.

19. The aerial device according to claim 1, wherein the controller, in the occurrence of a failure or an error or wear of one of the electric motors, activates at least a different one of the plurality of electric motors for the purpose of a partial or complete compensation and/or assumption of the lost power.

20. The aerial device according to claim 1, wherein a braking device is provided that, in the case of occurrence of an error, acts on the rotor drive shaft.

21. The aerial device according to claim 1, wherein the aerial device is a drone or a helicopter or a multicopter.

22. The aerial device according to claim 1, wherein the aerial device is equipped with means for providing a radio connection.

23. The aerial device according to claim 1, wherein the aerial device is equipped with means for providing lightning protection for an event site.
